(19) United States
(12) Patent Application Publication
(10) Pub. No.: US 2024/0303505 A1
(43) Pub. Date: Sep. 12, 2024

(54) FEDERATED LEARNING METHOD AND DEVICE USING DEVICE CLUSTERING

(71) Applicant: AJOU UNIVERSITY INDUSTRY-ACADEMIC COOPERATION FOUNDATION, Suwon-si (KR)

(72) Inventors: Young-Bae Ko, Suwon-si (KR); June-Pyo Jung, Seoul (KR)

(73) Assignee: AJOU UNIVERSITY INDUSTRY-ACADEMIC COOPERATION FOUNDATION, Suwon-si (KR)

(21) Appl. No.: 18/595,389

(22) Filed: Mar. 4, 2024

(30) Foreign Application Priority Data
Mar. 7, 2023 (KR) 10-2023-0030073

(51) Int. Cl. G06N 3/098

(52) U.S. Cl. CPC G06N 3/098

(57) ABSTRACT

Disclosed are a federated learning method and device using device clustering. The federated learning method includes obtaining an arbitrary client group including some clients as a result of performing clustering on a plurality of clients; determining one of the some clients as a leader client based on a centroid associated with the clustering, wherein the leader client receives data associated with at least one parameter of a pre-trained model from each of the some clients; determining at least one client among the some clients as a target client based on an amount of computing resources of the pre-trained model and a training loss of the pre-trained model; and receiving some data associated with at least one parameter of the model of the target client from the leader client, wherein the some data is included in the data.

### CROSS-REFERENCE TO RELATED APPLICATIONS

This application claims priority to and the benefit of Korean Patent Application No. 10-2023-0030073 filed in the Korean Intellectual Property Office on Mar. 7, 2023, the entire contents of which are incorporated herein by reference.

### BACKGROUND

Embodiments of the present disclosure described herein relate to a federated learning method and device using device clustering.

With the rapid development of big data, the use of artificial intelligence (AI) has increased significantly. International Data Corporation predicts that the amount of data generated through Internet of Things (IoT) devices will reach 79.4 ZB by 2025. In addition, it is expected to exceed the capacity of IoT and mobile devices globally. Most of the data generated by devices is processed on local or remote cloud servers.

### SUMMARY

Embodiments of the present disclosure provide a federated learning method and device that groups clients through device clustering and selects some clients to participate in federated learning within the client group based on the above-described background technology.

According to an embodiment, a federated learning method using device clustering performed by at least one processor includes obtaining an arbitrary client group including some clients as a result of performing clustering on a plurality of clients; determining one of the some clients as a leader client based on a centroid associated with the clustering, wherein the leader client receives data associated with at least one parameter of a pre-trained model from each of the some clients; determining at least one client among the some clients as a target client based on an amount of computing resources of the pre-trained model and a training loss of the pre-trained model; and receiving some data associated with at least one parameter of the model of the target client from the leader client, wherein the some data is included in the data.

According to an embodiment, a first training loss associated with the target client may be greater than a second training loss associated with an arbitrary client that is not the target client among some of the clients.

According to an embodiment, the clustering may be performed based on each communication distance between the plurality of clients.

According to an embodiment, the determining of the one client as the leader client may include determining one client with a shortest distance to the centroid among the some clients as the leader client based on the centroid associated with the clustering.

According to an embodiment, the clustering may include K-means clustering.

According to an embodiment, the federated learning method may further include calculating a weight based on an amount of computing resources of the target client by using the some data; and generating a global model by using the weight and the at least one parameter of the model of the target client.

According to another embodiment, there is provided a computer program recorded on a computer-readable recording medium to execute a federated learning method using device clustering.

According to an embodiment, a federated learning device using device clustering includes a communication module; at least one processor that transmits or receives data to or from an external device through the communication module; and a memory that stores at least some of the data, wherein the at least one processor includes instructions to obtain an arbitrary client group including some clients as a result of performing clustering on a plurality of clients; determine one of the some clients as a leader client based on a centroid associated with the clustering, wherein the leader client receives data associated with at least one parameter of a pre-trained model from each of the some clients; determine at least one client among the some clients as a target client based on an amount of computing resources of the pre-trained model and a training loss of the pre-trained model; and receive some data associated with at least one parameter of the model of the target client from the leader client.

According to some embodiments of the present disclosure, communication resource consumption and network delay due to short-range wireless communication may be effectively reduced and system coverage may be increased.

This disclosure has been supported by the sensor-fusion-based D2D collaborative ultra-precision positioning technology research project for realistic media, which is part of the Ministry of Science and ICT's individual basic research (Ministry of Science and ICT). (Project Implementation Agency: Ajou University; Project Management Agency: National Research Foundation of Korea; Project Period: Sep. 1, 2020˜Feb. 29, 2024)

### BRIEF DESCRIPTION OF THE FIGURES

The above and other objects and features of the present disclosure will become apparent by describing in detail embodiments thereof with reference to the accompanying drawings.

FIG. 1 is a diagram illustrating an example of a federated learning system using device clustering according to an embodiment of the present disclosure;

FIG. 2 is a block diagram illustrating the internal configurations of a user terminal and an information processing system according to an embodiment of the present disclosure;

FIG. 3 is a diagram illustrating an artificial neural network model according to an embodiment of the present disclosure;

FIG. 4 is a flowchart illustrating a federated learning method using device clustering according to an embodiment of the present disclosure; and

FIGS. 5A and 5B are graphs illustrating the model convergence and resource consumption reduction effects of a federated learning method according to an embodiment of the present disclosure.

### DETAILED DESCRIPTION

Hereinafter, embodiments of the present disclosure will be described in detail with reference to the accompanying drawings. In addition, a detailed description of well-known features or functions will be ruled out in order not to unnecessarily obscure the gist of the present disclosure.

In the accompanying drawings, the same or corresponding components will be assigned with the same reference numeral. In addition, in the description of the following embodiments, overlapping descriptions of the same or corresponding components may be omitted. However, omission of a description of a component does not intend that such a component is not included in an embodiment.

Advantages and features of embodiments of the present disclosure, and method for achieving thereof will be apparent with reference to the accompanying drawings and detailed description that follows. But, it should be understood that the present disclosure is not limited to the following embodiments and may be embodied in different ways, and that the embodiments are given to provide complete disclosure and to provide thorough understanding of the present disclosure to those skilled in the art.

The terms used herein will be briefly described, and the disclosed embodiments will be described in detail. With respect to the terms used in an embodiment of the present disclosure, general terms currently and widely used are selected in view of function with respect to the disclosure. However, the terms may vary according to an intention of a technician practicing in the pertinent art, an advent of new technology, etc. In specific cases, terms may be chosen arbitrarily, and in this case, definitions thereof will be described in the description of the corresponding disclosure. Accordingly, the terms used in the description should not necessarily be construed as simple names of the terms, but be defined based on meanings of the terms and overall contents of the present disclosure.

In the present disclosure, singular forms are intended to include plural forms unless the context clearly indicates otherwise. In addition, plural forms are intended to include singular forms unless the context clearly indicates otherwise. Throughout the specification, when some part ‘includes’ some elements, unless explicitly described to the contrary, it means that other elements may be further included but not excluded.

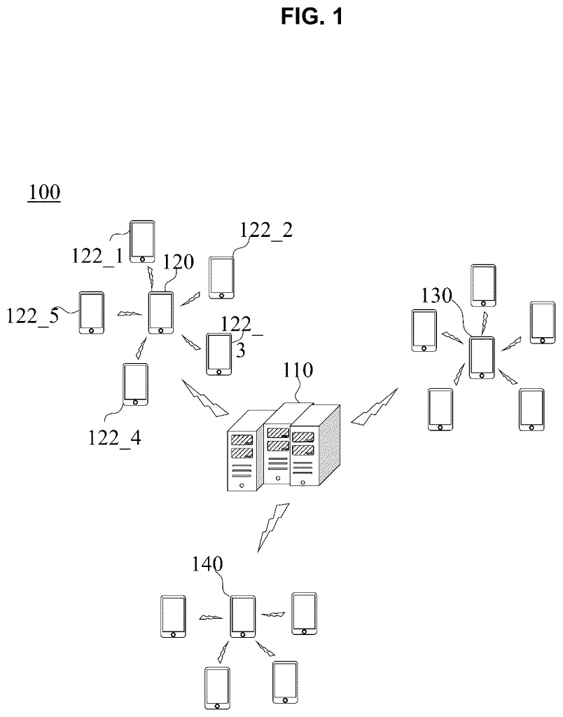

FIG. 1 is a diagram illustrating an example of a federated learning system 100 using device clustering according to an embodiment of the present disclosure. As shown, the system 100 may include a server 110 and a plurality of clients 120 to 140. In this case, the server 110 receives data representing parameters from at least some of the plurality of clients 120 to 140, and generates a global model by using the received data. In FIG. 1, an operation of a first client group associated with the first client 120 is described in detail later in order to explain a global model generation process of the server 110. That is, the operation of the server 110 with respect to the first client group may be equally applied to a second client group associated with the seventh client 130 and a third client group associated with the eighth client 140. Meanwhile, in this disclosure, ‘data representing parameters’ is referred to as ‘parameters’ for convenience of explanation.

Each of the plurality of clients 120 to 140 may use each learning dataset in advance to generate a machine learning model that is the basis of a global model. For example, the second client 122_1 may generate a machine learning model with a first parameter by using a first set of learning datasets, and the third client 122_2 may generate a machine learning model with a second parameter by using a second set of learning datasets. The parameter of the machine learning model pre-generated in such a manner may be later used by the server 110 when generating a global model.

The server 110 may determine some clients from among the plurality of clients 120 to 140 to obtain parameters. In detail, the server 110 may divide the plurality of clients 120 to 140 into a plurality of client groups and determine one leader client for each of the plurality of client groups to communicate directly with the server 110. Then, among the parameters of the remaining client(s) collected within the client group by the leader client, the parameters of each target client determined by the server 110 may be obtained through the leader client (in FIG. 1, the first client 120, the seventh client 130 and the eighth client 140). In this case, the parameter obtained from the target client may be used to generate the global model. Hereinafter, the operation of the above-described server 110 will be described in more detail.

The server 110 may perform clustering on the plurality of clients 120 to 140. For example, the server 110 may perform clustering on the plurality of clients 120 to 140 and generate the first client group including the first to sixth clients 120 to 122_5. In this case, each communication distance between the first to sixth clients 120 to 122_5 included in the first client group may be configured to be shorter than the communication distance from an arbitrary client among the first to sixth clients 120 to 122_5 to the seventh client 130. Similarly, each communication distance between the first to sixth clients 120 to 122_5 included in the first client group may be configured to be shorter than the communication distance from an arbitrary client among the first to sixth clients 120 to 122_5 to the eighth client 140.

The server 110 may determine one leader client within the cluster group. In detail, the server 110 may determine one leader client within an arbitrary cluster group based on a centroid associated with clustering. For example, the server 110 may determine the first client 120 located at the closest distance from the centroid that is the basis for clustering the first cluster group as the leader client. Meanwhile, the centroid related to clustering may refer to a centroid determined through K-means clustering.

The server 110 may obtain parameters of at least some of the remaining client(s) through the leader client and generate a global model through federated learning using the obtained parameters. To this end, the leader client within the client group may first obtain the parameters of some of the remaining client(s). For example, the first client 120 may obtain a parameter of a pre-trained model of each of some clients 122_1 to 122_5. In addition, the server 110 may determine one or more target clients among the remaining client(s) to transmit parameters through the leader client. For example, the server 110 may determine the third client 122_2 and the sixth client 122_5 as the target clients based on the amount of computing resources of each pre-trained model and/or the training loss of the pre-trained model. and to some clients 122_1 to 122_5. In response, the first client 120, which is the leader client, may transmit the model parameters of the third client 122_2 and the model parameters of the sixth client 122_5 to the server 110.

The server 110 may generate (or update) the global model based on the data received from the leader client. In detail, the server 110 may generate the global model with a loss function calculated based on the obtained parameters. Meanwhile, the server 110 may obtain parameters of at least some different client(s) from the leader client for each learning round. For example, in the first round in which the server 110 trains a global model, the server 110 may receive the parameter of the model of the third client 122_2 and the parameter of the model of the sixth client 122_5 from the leader client. Then, the server 110 may receive the parameter of the model of the third client 122_2 and the parameter of the model of the fourth client 122_3 in the second round after the first round. That is, the server 110 may obtain the amount of computing resources and/or training-loss of each of some clients 122_1 to 122_5 in each round of learning, and update the target client of which the parameter is to be obtained based on the amount of computing resources and/or training-loss obtained.

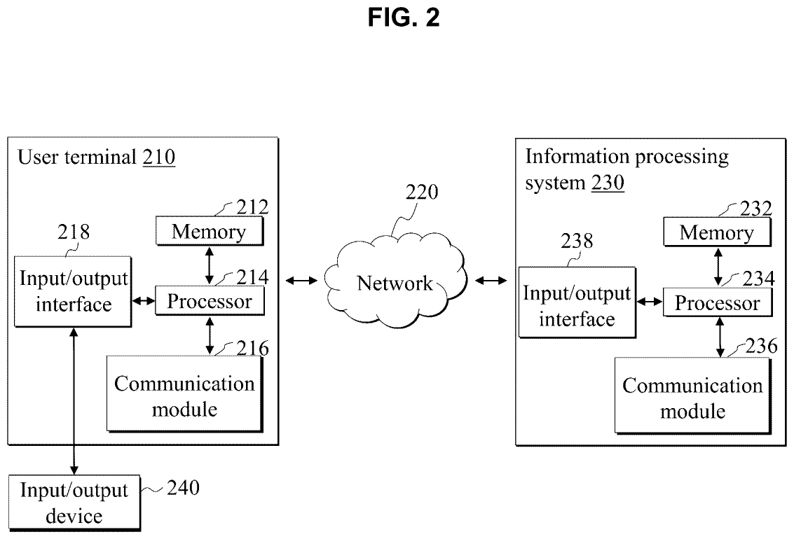

FIG. 2 is a block diagram illustrating the internal configurations of a user terminal 210 and an information processing system 230 according to an embodiment of the present disclosure. In this case, the user terminal 210 may correspond to ‘client’ in this disclosure. In addition, in the present disclosure, the user terminal 210 may refer to an arbitrary computing device capable of executing a machine learning modeling program, or the like and capable of wired/wireless communication, and as shown, the user terminal 210 may include a memory 212, a processor 214, a communication module 216, and an input/output interface 218. Similarly, the information processing system 230 may include a memory 232, a processor 234, a communication module 236, and an input/output interface 238. As shown in FIG. 2, the user terminal 210 and the information processing system 230 may be configured to communicate information and/or data through a network 220 by using respective communication modules 216 and 236. In addition, an input/output device 240 may be configured to input information and/or data (e.g., user information, goal information, and the like) to the user terminal 210 through the input/output interface 218 or output information and/or data generated from the user terminal 210.

The memory 212 or 232 may include a non-transitory computer-readable recording medium. According to an embodiment, the memory 212 or 232 may include a permanent mass storage device such as a random access memory (RAM), a read only memory (ROM), a disk drive, a solid state drive (SSD), a flash memory, and the like. As another example, a permanent mass storage device such as a ROM, an SSD, a flash memory, a disk drive, and the like may be included in the user terminal 210 or the information processing system 230 as a separate permanent storage device that is distinct from a memory. In addition, the memory 212 or 232 may store an operating system and at least one program code (e.g., a code installed in the user terminal 210 to execute a machine learning modeling program).

Such software components may be loaded from a computer-readable recording medium separate from the memory 212 or 232. Such a separate computer-readable recording medium, which includes a recording medium directly connectable to the user terminal 210 and the information processing system 230, may include a computer-readable recording medium such as a floppy drive, a disk, a tape, a DVD/CD drive, a memory card, and the like. As another example, software components may be loaded into the memory 212 or 232 through the communication module 216 or 236 rather than through a computer-readable recording medium. For example, at least one program may be loaded into the memory 212 or 232 based on a computer program installed by files provided through the network 220 by developers or a file distribution system that distributes the installation file of an application.

The processors 214 and 234 may be configured to process commands of a computer program by performing basic arithmetic, logic, and input/output operations. The commands may be provided to the processor 214 or 234 by the memory 212 or 232 or the communication module 216 or 236. For example, the processor 214 or 234 may be configured to execute the command received according to the program code stored in a recording device such as the memory 212 or 232.

The communication modules 216 and 236 may provide configurations or functions for the user terminal 210 and the information processing system 230 to communicate with each other through the network 220, and configurations or functions for the user terminal 210 and/or the information processing system 230 to communicate with other user terminals or other systems (e.g., a separate cloud system, and the like). For example, data (e.g., data including information about a pre-trained model, model parameters, an amount of computing resources, a training loss, and the like) generated by the processor 214 of the user terminal 210 according to the program code stored in a recording device such as the memory 212 may be transmitted to the information processing system 230 through the network 220 under the control of the communication module 216. To the contrary, a control signal or command (e.g., a client's location information request, or a data request) provided under the control of the processor 234 of the information processing system 230 may be received by the user terminal 210 through the communication module 216 of the user terminal 210 via the communication module 236 and the network 220.

The input/output interface 218 may be a unit for interaction with the input/output device 240. In detail, the input/output device 240 may include an input device such as a camera including an audio sensor and/or an image sensor, a keyboard, a microphone, a mouse, and the like. In addition, the input/output device 240 may include an output device such as a display, a speaker, a haptic feedback device, and the like. As another example, the input/output interface 218 may be a unit for interfacing with a device that has a structure or function for performing input and output, such as a touch screen, integrated into one.

Although the input/output device 240 that is not included in the user terminal 210 is shown in FIG. 2, the present invention is not limited to this and may be configured as a single device with the user terminal 210. In addition, the input/output interface 238 of the information processing system 230 may be connected to the information processing system 230 or be a unit for interfacing with a device (not shown) for input or output that may be included in the information processing system 230. Although the input/output interfaces 218 and 238 are shown in FIG. 2 as elements configured separately from the processors 214 and 234, the embodiment invention is not limited thereto, and the input/output interfaces 218 and 238 may be configured to be included in the processors 214 and 234.

The user terminal 210 and the information processing system 230 may include more components than those in FIG. 2. However, there is no need to clearly show most components according to the related art. According to an embodiment, the user terminal 210 may be implemented to include at least some of the input/output devices 240 described above. In addition, the user terminal 210 may further include other components such as a transceiver, a global positioning system (GPS) module, a camera, various sensors, a database, and the like. For example, when the user terminal 210 is a smartphone, it may include components that the smartphone generally includes. For example, various components such as an acceleration sensor, a gyro sensor, a microphone module, a camera module, various physical buttons, buttons using a touch panel, input/output ports, and the like may be implemented to be further included in the user terminal 210.

The processor 214 of the user terminal 210 may be configured to operate a program for controlling the user terminal 210 including a federated learning modeling function. In this case, the code associated with the program may be loaded into the memory 212 of the user terminal 210. While the program operates, the processor 214 of the user terminal 210 may receive information and/or data provided from the input/output device 240 through the input/output interface 218 or information and/or data from the information processing system 230 through the communication module 216, and may process the received information and/or data and store the processed information and/or data in the memory 212. In addition, such information and/or data may be provided to the information processing system 230 through the communication module 216 or 236.

The processor 234 of the information processing system 230 may be configured to manage, process, and/or store the information and/or data received from a plurality of user terminals and/or a plurality of external systems. According to an embodiment, the processor 234 may manage, process, and/or store the user input received from the user terminal 210 and the data processed according to the corresponding user input. Additionally or alternatively, the processor 234 may be configured to store and/or update a program for training and/or modeling an artificial intelligence model of the user terminal 210 from a separate cloud system, database, and the like connected to the network 220.

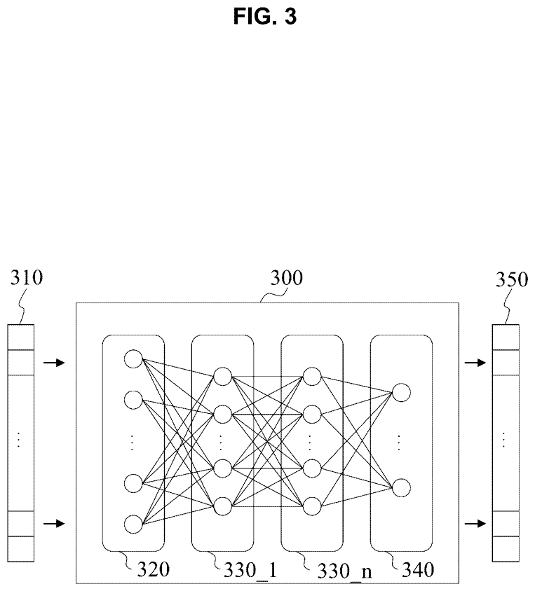

FIG. 3 is a diagram illustrating an artificial neural network model 300 according to an embodiment of the present disclosure. The artificial neural network model 300, which is an example of a machine learning model, is a statistical learning algorithm that is implemented based on the structure of a biological neural network or a structure that executes the algorithm, in machine learning technology and cognitive science.

In the artificial neural network model 300, nodes, which are artificial neurons that form a network by combining synapses as in a biological neural network, may learn to repeatedly adjust the weights of synapses and to reduce the error between the correct output corresponding to a specific input and an inferred output, thereby representing a machine learning model with a problem-solving capability. For example, the artificial neural network model 300 may include an arbitrary probability model, a neural network model, and the like used in an artificial intelligence learning scheme such as machine learning, deep learning, and the like, and may include a model associated with the deep neural network described above.

The artificial neural network model 300 is implemented as a multilayer perceptron (MLP) including multiple layers of nodes and connections between them. The artificial neural network model 300 according to the present embodiment may be implemented using one of various artificial neural network model structures including MLP. As shown in FIG. 3, the artificial neural network model 300 includes an input layer 320 that receives an input signal or data 310 from an outside, and an output layer 340 that outputs an output signal or data 350 corresponding to input data, and n hidden layers 330_1 to 330_n that are located between the input layer 320 and the output layer 340, receive a signal from the input layer 320, extract a feature, and transmit the feature to the output layer 340 (where n is a positive integer). In this case, the output layer 340 receives signals from the hidden layers 330_1 to 330_n and outputs them to the outside.

The learning method of the artificial neural network model 300 includes a supervised learning method that learns to optimize problem solving by inputting a teacher signal (correct answer), and an unsupervised learning method that does not require a teacher signal. For example, the artificial neural network model 300 associated with a deep neural network may be a supervised and/or unsupervised model learned using training data. The artificial neural network model 300 learned in such a manner may be stored in the memory (not shown) of a computing device, and the computing device may perform quantization on the artificial neural network model 300. For example, the computing device may quantize the weight, the output value, and/or the input value of the artificial neural network model 300 learned as a 32-bit floating point into discretized values (e.g., integers).

According to an embodiment, the computing device may perform quantization on the artificial neural network model 300 without using the training data used to learn the artificial neural network model 300. For example, the artificial neural network model 300 may include a plurality of normalization layers, and quantization may be performed on input values of the layer following each normalization layer. In this case, the computing device may perform quantization on the output value (activation output) by using the statistical characteristics of the normalization layer (standardization factor of the normalization layer). In other words, the computing device may determine a clipping value associated with a plurality of output values of the normalization layer from statistical information extracted from the normalization layer without at least part of the learning data used when training the artificial neural network model 300, and may use the determined clipping value and the number of bits of data used during inference in the artificial neural network model 300 to determine the discretization interval associated with the input values of the subsequent layer.

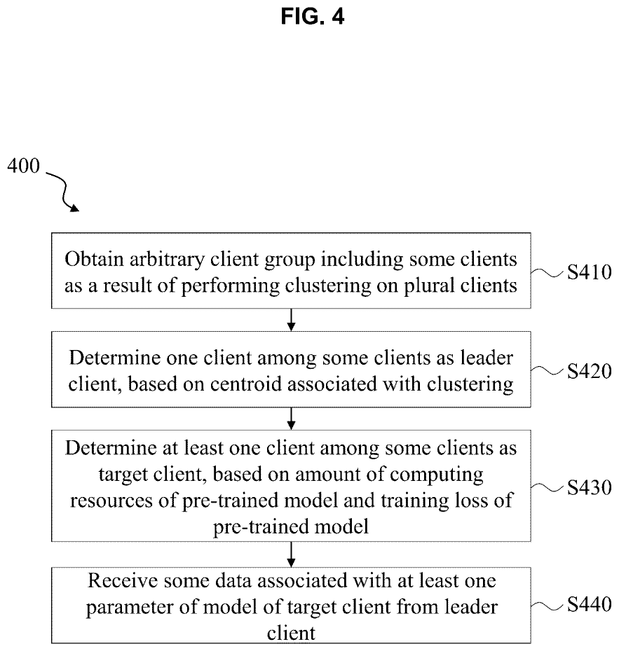

FIG. 4 is a flowchart illustrating a federated learning method 400 using device clustering according to an embodiment of the present disclosure. The method 400 may be performed by at least one processor of a computing device such as a client, a user terminal, and the like. Meanwhile, as shown, the method 400 may begin with operation S410 of obtaining an arbitrary client group including some clients as a result of performing clustering on a plurality of clients. In this case, clustering may be performed based on each communication distance between the plurality of clients. In addition, all conventional clustering schemes may be used for clustering, and as an example, the K-means clustering scheme may be used.

In operation S420, the processor may determine one client among some clients as the leader client, based on a centroid associated with clustering. For example, based on the centroid associated with clustering, the processor may determine one client with the shortest distance to the centroid among some clients as the leader client. In this case, the leader client may receive data associated with at least one parameter of a pre-trained model from each of some clients. Then, in operation S430, the processor may determine at least one client among some clients as the target client, based on the amount of computing resources of the pre-trained model and the training loss of the pre-trained model. In this case, the first training loss associated with the target client may be configured to be greater than the second training loss associated with an arbitrary client that is not the target client among some clients.

In operation S440, the processor may receive some data associated with at least one parameter of the model of the target client from the leader client. In this case, some data may be included in the data associated with at least one parameter described above. In addition, the processor may use some data to calculate a weight based on the amount of computing resources of the target client and generate a global model by using the weight and at least one parameter of the model of the target client.

According to another embodiment of the present disclosure, there may be provided a computer program recorded on a computer-readable recording medium to execute a federated learning method using device clustering.

According to another embodiment of the present disclosure, a federated learning device using device clustering may include a communication module, at least one processor configured to transmit or receive data to or from an external device through the communication module, and a memory configured to store at least some of the data, where the at least one processor includes instructions to obtain an arbitrary client group including some clients as a result of performing clustering on a plurality of clients, determine one of the some clients as a leader client based on a centroid associated with the clustering, where the leader client receives data associated with at least one parameter of a pre-trained model from each of the some clients, determine at least one client among the some clients as a target client based on an amount of computing resources of the pre-trained model and a training loss of the pre-trained model, and receive some data associated with at least one parameter of the model of the target client from the leader client.

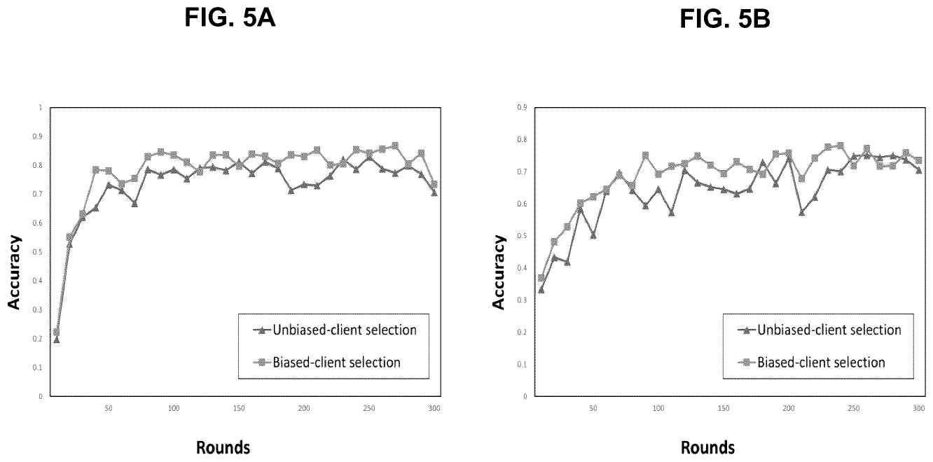

FIGS. 5A and 5B are graphs illustrating the model convergence and resource consumption reduction effects of a federated learning method according to an embodiment of the present disclosure. In detail, FIG. 5A is an example in which MNIST is used as the learning dataset, and FIG. 5B is an example in which FashionMNIST is used as the learning dataset. As shown, it may be understood that the model accuracy converges similarly in both the biased client selection method according to the federated learning method of the present disclosure and the unbiased client selection method according to the conventional method. In particular, it may be understood that biased client selection, as in the federated learning method of the present disclosure, converges to a certain level of accuracy more quickly, and the accuracy is also higher than that of a conventional method. This means that when adopting a biased customer selection method such as the federated learning method of the present disclosure, sufficient results are produced even with a small number of clients.

The preceding description of the present disclosure is provided to enable those having ordinary skill in the art to make or use the present disclosure. Various modifications of the present disclosure will be readily apparent to those skilled in the art, and the general principles defined herein may be applied in various modifications without departing from the spirit or scope of the present disclosure. Thus, the present disclosure is not intended to be limited to the examples set forth herein but is to be accorded the widest scope consistent with the principles and novel features disclosed herein.

While the present disclosure has been described with reference to embodiments thereof, it will be apparent to those of ordinary skill in the art that various changes and modifications may be made thereto without departing from the spirit and scope of the present disclosure as set forth in the following claims. Moreover, such modifications and variations are intended to fall within the scope of the claims appended hereto.

What is claimed is:

1. A federated learning method using device clustering performed by at least one processor, the federated learning method comprising:
obtaining an arbitrary client group including some clients as a result of performing clustering on a plurality of clients;
determining one of the some clients as a leader client based on a centroid associated with the clustering, wherein the leader client receives data associated with at least one parameter of a pre-trained model from each of the some clients;
determining at least one client among the some clients as a target client based on an amount of computing resources of the pre-trained model and a training loss of the pre-trained model; and
receiving some data associated with at least one parameter of the model of the target client from the leader client, wherein the some data is included in the data.

2. The federated learning method of claim 1, wherein a first training loss associated with the target client is greater than a second training loss associated with an arbitrary client that is not the target client among some of the clients.

3. The federated learning method of claim 1, wherein the clustering is performed based on each communication distance between the plurality of clients.

4. The federated learning method of claim 1, wherein the determining of the one client as the leader client includes determining one client with a shortest distance to the centroid among the some clients as the leader client based on the centroid associated with the clustering.

5. The federated learning method of claim 1, wherein the clustering includes K-means clustering.

6. The federated learning method of claim 1, further comprising:
calculating a weight based on an amount of computing resources of the target client by using the some data; and
generating a global model by using the weight and the at least one parameter of the model of the target client.

7. A computer program recorded on a computer-readable recording medium to execute a federated learning method using device clustering according to claim 1.

8. A federated learning device using device clustering, the federated learning device comprising:
a communication module;
at least one processor configured to transmit or receive data to or from an external device through the communication module; and
a memory configured to store at least some of the data,
wherein the at least one processor includes instructions to:
obtain an arbitrary client group including some clients as a result of performing clustering on a plurality of clients;
determine one of the some clients as a leader client based on a centroid associated with the clustering, wherein the leader client receives data associated with at least one parameter of a pre-trained model from each of the some clients;
determine at least one client among the some clients as a target client based on an amount of computing resources of the pre-trained model and a training loss of the pre-trained model; and
receive some data associated with at least one parameter of the model of the target client from the leader client.
